(19) United States
(12) Patent Application Publication
(10) Pub. No.: US 2004/0112959 A1
(43) Pub. Date: Jun. 17, 2004

(54) Terminal for collecting taxi fare and providing additional services

(76) Inventor: Young-Sam Jun, Seoul (KR)

Correspondence Address: CANTOR COLBURN LLP, 55 Griffin Road South, Bloomfield, CT, 06002, US

(21) Appl. No.: 10/373,598

(22) Filed: Feb. 25, 2003

(30) Foreign Application Priority Data
Dec. 11, 2002 (KR) 2002-78760

(51) Int. Cl. G07B 15/02

(52) U.S. Cl. 235/384

(57) ABSTRACT

A terminal of a system for collecting fares using passengers' various cards and providing various additional services is provided. A taxi fare collection terminal is connected to a service providing server through a wireless network. The taxi fare collection terminal includes a driver operation panel installed in front of driver's seat, a passenger information display unit in front of passenger's seat, and a controller including a plurality of input/output ports for connection to a taxi meter, the driver operation panel, and the passenger information display unit and a wireless communication unit communicating with the service providing server through the wireless network, receiving black list (B/L) information or positive list (P/L) information from the service providing server and managing the B/L or P/L information, controlling the passenger information display unit to display fare information received from the taxi meter, comparing passenger card information received from the passenger information display unit with the B/L or P/L information to settle the payment of a taxi fare, and transmitting additional service information received from the service providing server to the driver operation panel and/or the passenger information display unit.

### BACKGROUND OF THE INVENTION

1 Field of the Invention

The present invention relates to a terminal of a system for collecting a taxi fare using passengers' various types of cards, and more particularly, to a terminal for collecting a taxi fare and providing various additional services.

2. Description of the Related Art

When a passenger does not have cash or when a taxi driver does not have enough changes, payment of a taxi fare likely takes some time or a quarrel likely happens between the taxi driver and the passenger. Therefore, schemes for settling the payment of taxi fares by passengers' various cards have been actively suggested.

In the meantime, in order to prevent crimes of violence such as taxi robberies, a safety shield is installed between driver's seat and passenger's seat in a taxi in some nations and districts. Under such this environment, a system for collecting a taxi fare so that the payment of a taxi fare can be safely and conveniently settled is desired. However, since it is not economical to construct this system only for collecting a taxi fare, a system for collecting a taxi fare using a passenger's radio frequency (RF) card has not been actively used.

### SUMMARY OF THE INVENTION

The present invention provides a terminal for safely and conveniently collecting a taxi fare in a taxi in which a safety shield is installed between driver's seat and passenger's seat and providing call information to a taxi driver and various additional services to a passenger.

According to an aspect of the present invention, there is provided a taxi fare collection terminal connected to a service providing server through a wireless network. The taxi fare collection terminal includes a controller, a driver operation panel, and a passenger information display unit. The controller includes a plurality of input/output ports for connection to a taxi meter, the driver operation panel, and the passenger information display unit and a wireless communication unit communicating with the service providing server through the wireless network. The controller receives black list (B/L) information or positive list (P/L) information from the service providing server and managing the B/L or P/L information, controls the passenger information display unit to display fare information received from the taxi meter, compares passenger card information received from the passenger information display unit with the B/L or P/L information to settle the payment of a taxi fare, and transmits additional service information received from the service providing server to the driver operation panel and/or the passenger information display unit. The driver operation panel is installed in front of driver's seat and connected to an input/output port of the controller. The driver operation panel includes a driver card reader unit, which wirelessly reads driver card information from a driver's card and transmits the driver card information to the controller; a driver keypad receiving selection commands from the driver; and a driver display outputting information received from the controller. The passenger information display unit is installed in front of passenger's seat and connected to an input/output port of the controller. The passenger information display unit includes a passenger card reader unit, which wirelessly reads passenger card information from a passenger's card and transmits the passenger card information to the controller; a passenger keypad receiving card secrete number from the passenger; and a passenger display outputting information received from the controller.

According to another aspect of the present invention, there is provided a taxi fare collection terminal connected to a service providing server through a wireless network. The taxi fare collection terminal includes a controller, a driver operation panel, and a passenger information display unit. The controller includes a plurality of input/output ports for connection to a taxi meter, the driver operation panel, and the passenger information display unit and a wireless communication unit communicating with the service providing server through the wireless network. The controller controls the passenger information display unit to display fare information received from the taxi meter, makes an on-line connection to the service providing server to transmit passenger card information received from the passenger information display unit to the service providing server in order to settle the payment of a taxi fare, and transmits additional service information received from the service providing server to the driver operation panel and/or the passenger information display unit. The driver operation panel is installed in front of driver's seat and connected to an input/output port of the controller. The driver operation panel includes a driver card reader unit, which wirelessly reads driver card information from a driver's card and transmits the driver card information to the controller; a driver keypad receiving selection commands from the driver; and a driver display outputting information received from the controller. The passenger information display unit is installed in front of passenger's seat and connected to an input/output port of the controller. The passenger information display unit includes a passenger card reader unit, which wirelessly reads passenger card information from a passenger's card and transmits the passenger card information to the controller; a passenger keypad receiving card secrete number from the passenger; and a passenger display outputting information received from the controller.

### BRIEF DESCRIPTION OF THE DRAWINGS

The above aspects and advantages of the present invention will become more apparent by describing in detail preferred embodiments thereof with reference to the attached drawings in which:

FIG. 1 is a diagram of an environment in which a taxi fare collection terminal according to the present invention operates;

FIG. 2 is a schematic block diagram of a taxi fare collection terminal according to an embodiment of the present invention;

FIG. 3 is a diagram of an environment in which a taxi fare collection terminal according to the present invention is installed in a taxi;

FIG. 4 is a detailed block diagram of a controller of the taxi fare collection terminal shown in FIG. 2;

FIG. 5 is a detailed block diagram of a driver operation panel of the taxi fare collection terminal shown in FIG. 2;

FIG. 6 is a front view of an embodiment of the driver operation panel shown in FIG. 5;

FIG. 7 is a plane view of an embodiment of the driver operation panel shown in FIG. 5;

FIG. 8 is a detailed block diagram of a passenger information display unit of the taxi fare collection terminal shown in FIG. 2;

FIG. 9 is a front view of an embodiment of the passenger information display unit shown in FIG. 8; and

FIGS. 10A and 10B are flowcharts of an embodiment of procedures of collecting a taxi fare and providing additional services to a driver and a passenger using a taxi fare collection terminal according to the present invention.

### DETAILED DESCRIPTION OF THE INVENTION

Hereinafter, preferred embodiments of the present invention will be described in detail with reference to the attached drawings.

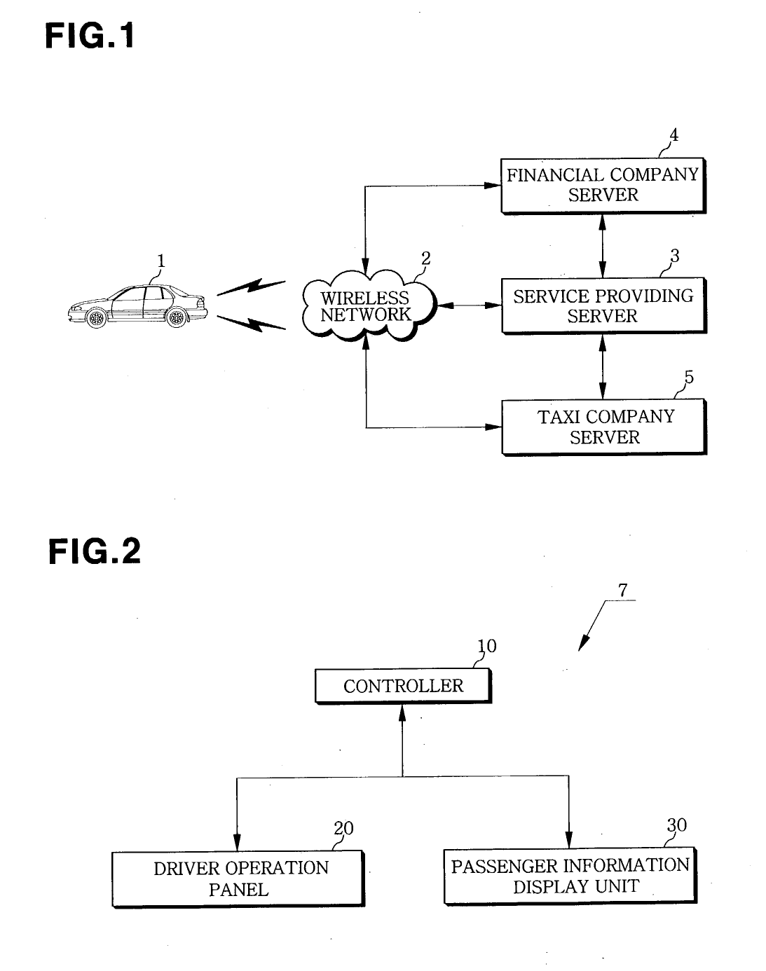

A taxi fare collection terminal according to the present invention is installed in a taxi 1 as an element of a taxi fare collection system providing additional services, as shown in FIG. 1. Referring to FIG. 1, the taxi fare collection system providing additional services includes a service providing server 3, a financial company server 4, a taxi company server 5, and a taxi fare collection terminal installed in the taxi 1. The service providing server 3 is connected to the financial company server 3 and the taxi company server 5 through a network. The taxi fare collection terminal is connected to the service providing server 3, the financial company server 4, and the taxi company server 5 through a wireless network 2. The wireless network 2 indicates a comprehensive network including a wireless communication network such as a code division multiple access (CDMA) mobile communication network or high-speed private wireless communication, Internet, and a gateway connecting the wireless communication network to the Internet.

The taxi fare collection terminal of the present invention is connected to the service providing server 3 through the wireless network 2 and transmits and receives information for settling the payment of a taxi fare and providing additional services. In the meantime, the service providing server 3 is connected to the financial company server 4 through the network in order to settle the payment of a taxi fare and to the taxi company server 5 through the network to provide additional services. Here, it is preferable to use a private network rather than a public network such as the Internet as the network connecting the financial company server 4 and the taxi company server 5 to the service providing server 3 in terms of security.

While the service providing server 3 is shown like a single server apparatus in FIG. 1, it should be understood as an entity including at least one server apparatus, which is connected to taxi fare collection terminals through the wireless network 2 and provides services, in functional aspect rather than structural aspect. Accordingly, it will be easily understood by one of ordinary skill in the art of the present invention that the service providing server 3 can be implemented by a single computer system or a plurality of computer system connected through a network.

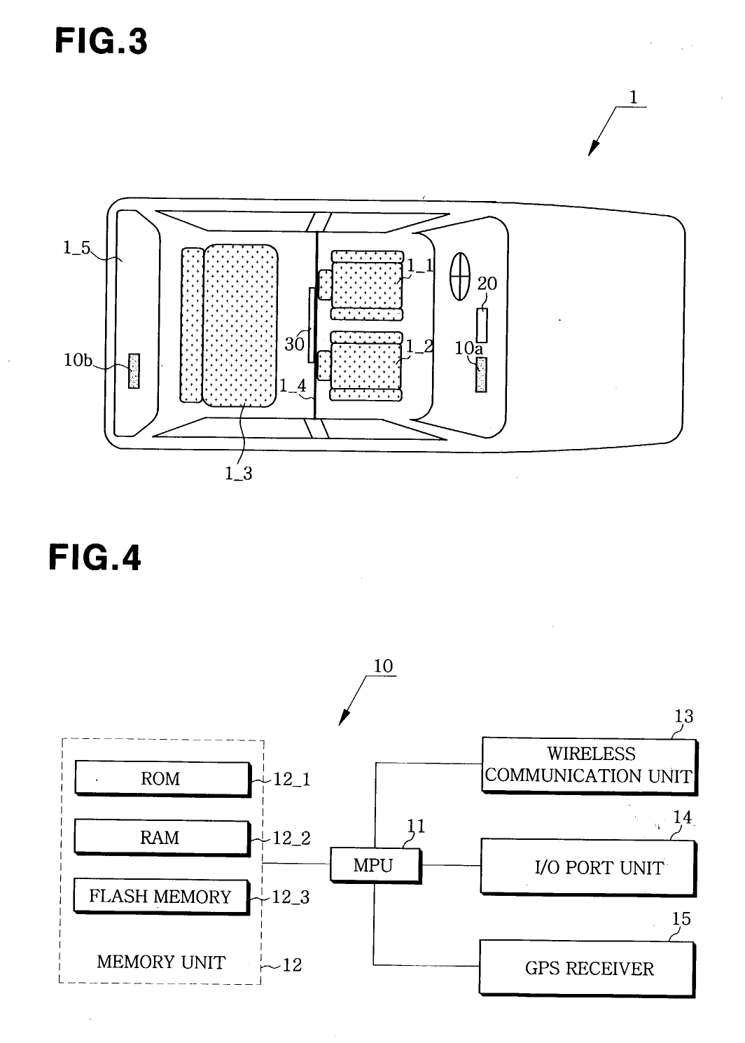

Referring to FIG. 2, a taxi fare collection terminal 7, an element of the taxi fare collection system shown in FIG. 1 providing additional service, includes a controller 10, a driver operation panel 20, and a passenger information display unit 30. As shown in FIG. 3, in a taxi 1 having a safety shield 1_4 for protecting a driver, preferably, the controller 10a or 10b is installed in front of an assistant's seat 1_2 or in a back trunk 1_5, the driver operation panel 20 is attached to the front of a driver's seat 1_1, and the passenger information display unit 30 is attached to the safety shield 1_4 in front of a passenger's seat 1_3. Here, the lower portion of the safety shield 1_4 is made of an iron plate, and the upper portion thereof is made of bulletproof glass.

Referring to FIG. 4, the controller 10 includes a microprocessor unit (MPU) 11, a memory unit 12, a wireless communication unit 13, an input/output (I/O) port unit 14 including a plurality of I/O ports, and a global positioning system (GPS) receiver 15. The MPU, 11 may be a commercialized universal microprocessor and is preferably a 32-bit microprocessor in terms of processing capacity.

The memory unit 12 includes a read-only memory (ROM) 12_1 for storing a control program executed in the MPU 11, a random access memory (RAM) 12_2 for storing data processed using the control program, a flash memory 12_3 for storing additional services information, logging information, and black list (B/L) information or positive list (P/L) information. Various types of information stored in the flash memory will be described in detail later.

The wireless communication unit 13 is provided to communicate with the service providing server 3 through the wireless network 2. The wireless communication unit 13 is a hardware and software module for accessing a CDMA mobile communication network and/or high-speed private wireless communication network.

The I/O port unit 14 is provided for connection among a taxi meter (not shown), the driver operation panel 20, and the passenger information display unit 30. For wired connection, a universal serial port (USB), a serial port, a parallel port, or an IEEE1394 port may be used. For wireless connection, a port using radio frequency, Bluetooth, or infrared data association (IrDA) may be used.

The GPS receiver 15 transmits GPS data (vehicle position information), which is obtained by demodulating a signal received from a GPS satellite, to the MPU 11. The GPS satellite orbits the earth with a period of 12 hours. The GPS receiver 15 uses a non-directional antenna. Since a low noise amplifier (LNA) provided in the GPS receiver 15 determines a minimum reception level, it is preferable to use a device having a satisfactory noise characteristic. The detailed structure of the GPS receiver 15 is known to one of ordinary skill in the art of the present invention, and thus a description thereof will be omitted.

The MPU 11 executes a control program to receive driver information from the driver operation panel 20, identify the driver, generate information such as the driver's shift schedules, and store the information as logging information for logging into the flash memory 12_3. In addition, the MPU 11 executing the control program generates additional service request information in response to a selection command (additional service request command) received from the driver operation panel 20 and uploads the additional service request information to the service providing server 3. The MPU 11 also downloads additional service information and B/L or P/L information from the service providing server 3 and stores them in the flash memory 12_3. Here, the additional service information includes, for example, advertisement information and new information to be displayed to a passenger. The additional service information is processed and managed by the service providing server 3. The B/L or P/L information is data for checking whether a passenger's card information can be used when the passenger pays a taxi fare by credit card and can be downloaded from the service providing server 3 at the driver's request or in a particular time period in bulk. When the wireless communication unit 13 of the controller 10 includes both a module for accessing a CDMA mobile communication network and a module for accessing a high-speed private wireless communication network, it is preferable that a large amount of information such as additional service information, B/L information, or P/L information is downloaded through a high-speed private wireless communication network.

On receiving fare information from the taxi meter, the MPU 11 executing the control program controls the driver operation panel 20 and the passenger information display unit 30 to display the fare information. On receiving passenger's card information from the passenger information display unit 30, the MPU 11 compares the passenger's card information with the B/L or P/L information stored in the flash memory 12_3 and settles the payment of a taxi fare when it is determined that the passenger's card can be used. Here, payment information is stored in the flash memory 12_3 as logging information. The payment information stored in the flash memory 12_3 includes the passenger's card information and the fare information.

The MPU 11 executing the control program controls the passenger information display unit 30 to display the additional service information received from the service providing server 3 according to a predetermined schedule and uploads the vehicle position information received through the GPS receiver 15 to the service providing server 3 with a predetermined period (for example, a period of one minute). In addition, the MPU 11 executing the control program generates passenger getting-on/off information in response to a selection command (passenger getting-on information upload command or passenger getting-off information upload command) received from the driver operation panel 20 and uploads the passenger getting-on/off information to the service providing server 3. The MPU 11 executing the control program also receives a call message from the service providing server 3 and transmits it to the driver operation panel 20. Here, the call message is generated by a manager of the service providing server 3 based on the vehicle position information and the passenger getting-on/off information received from taxi fare collection terminals 7 and caller position information received from a caller, i.e., a passenger wanting to take a taxi, through a telephone and is sent to the taxi fare collection terminal 7 of the taxi 1 that is geographically nearest to the caller in order to provide the position of the caller.

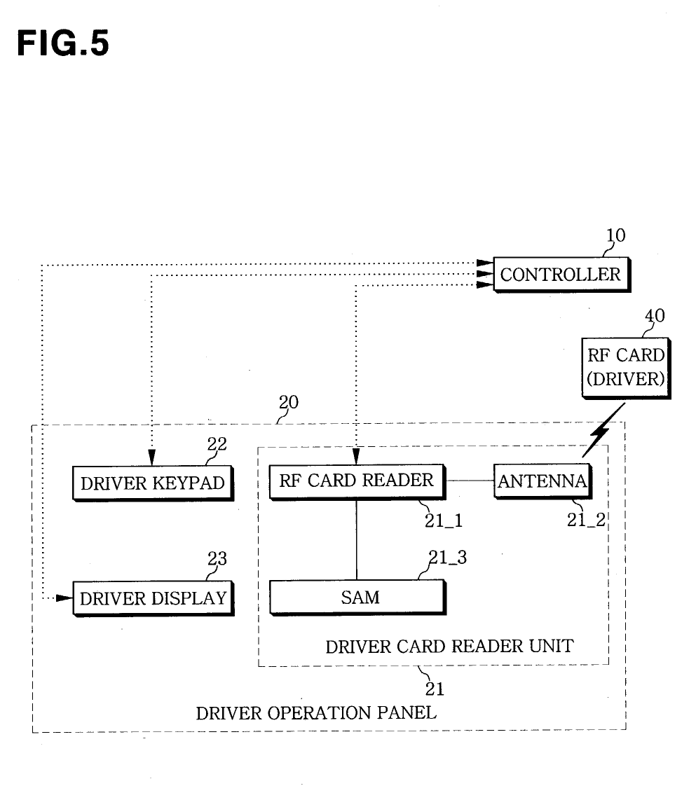

Referring to FIG. 5, the driver operation panel 20 is connected to the I/O port unit 14 of the controller 10 and includes a driver card reader unit 21, which wirelessly reads driver card information from a driver's RF card 40 and transmits it to the controller 10; a driver keypad 22 receiving a driver's selection command; and a driver display 23 outputting information received from the controller 10. The driver card reader unit 21 includes an antenna 21_2 receiving a card signal from the RF card 40 carried by the driver, an RF-card reader 21_1 reading card security information and driver information from the card signal received from the antenna 21_2, and a security access module (SAM) 21_3 checking the validity and security of the RF card 40 based on the card security information. The driver card reader unit 21 transmits the valid driver information to the MPU 11 of the controller 10. As shown in FIG. 7, the antenna 21_2 is realized as an RF-card antenna panel on the housing of the driver operation panel.

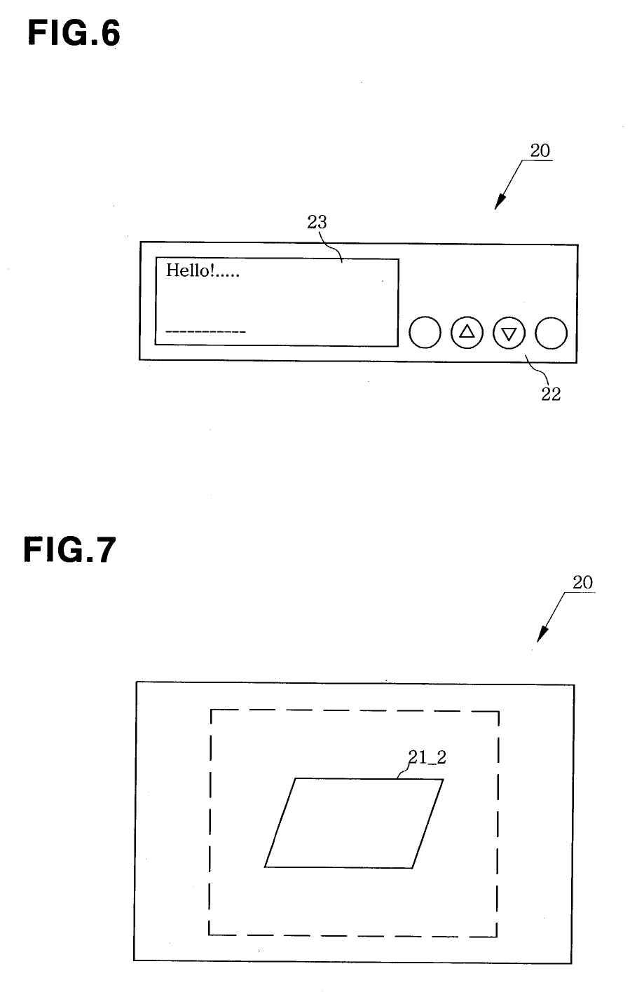

Referring to FIG. 6, the driver keypad 22 may include four keys, i.e., up and down keys for scrolling the driver display 23, a mode selection key, and a command selection key. The driver display 23 is preferably realized as a liquid crystal display (LCD), which can display three lines of 32 letters in English. However, it will be easily understood by one of ordinary skill in the art of the present invention that the configuration of the driver keypad 22 and the screen configuration of the driver display 23 can be varied depending on user interface for the driver operation panel 20 in the control program of the controller 10.

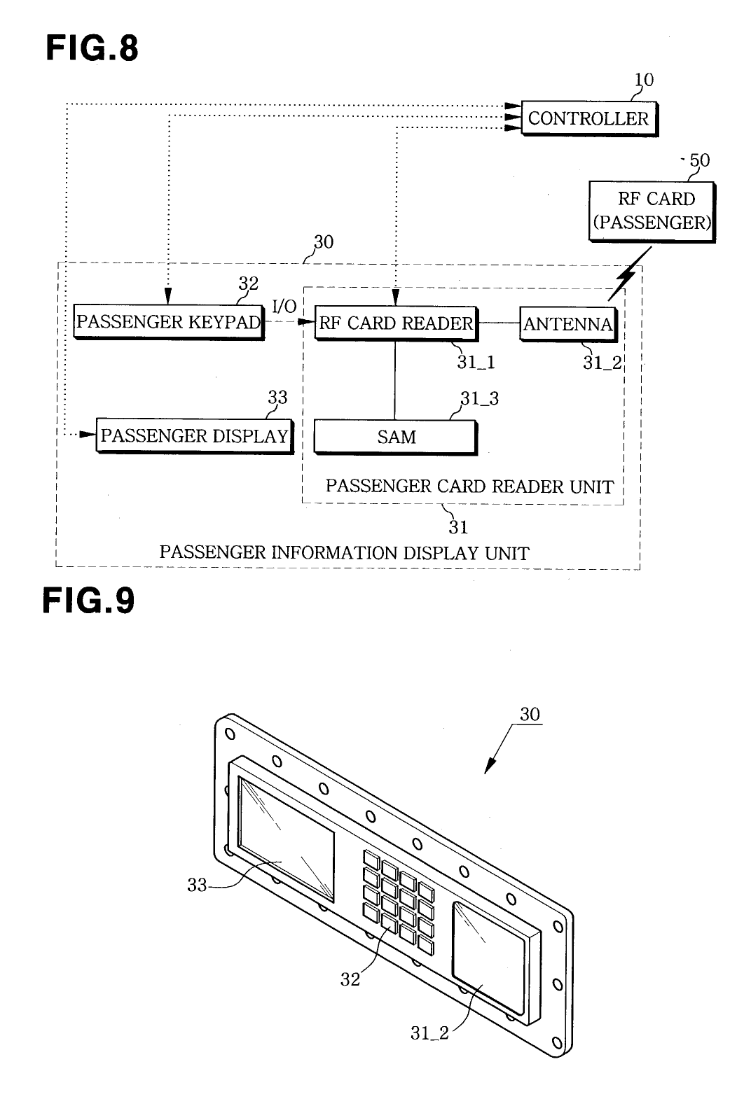

Referring to FIG. 8, the passenger information display unit 30 includes a passenger card reader unit 31, which reads passenger card information from a passenger's RF card 50 and transmits it to the controller 10; a passenger keypad 32 receiving a card password from the passenger; and a passenger display 33 outputting information received from the controller 10. The passenger card reader unit 31 includes an antenna 31_{—2} receiving a card signal from the RF card 50 carried by the passenger, an RF-card reader 31_{—1} reading card security information and passenger information from the card signal received from the antenna 31_{—2}, and a SAM 31_3 checking the validity and security of the RF card 50 based on the card security information. The passenger card reader unit 31 transmits the valid passenger information to the MPU 11 of the controller 10. As shown in FIG. 9, the antenna 31_2 is realized as an RF-card antenna panel in a front portion of the passenger information display unit 30. Here, the passenger's RF card 50 may be any non-contact type pay card using RF regardless of a settlement method of a card such as a prepay card, postpay card, or debit card.

Referring to FIG. 9, the passenger keypad 32 preferably includes at least 12 keys including 10 numeral keys for inputting a secret number of a credit card and selecting an additional function. The passenger display 33 is preferably realized as an LCD having 800*600 pixels. However, it will be easily understood by one of ordinary skill in the art of the present invention that the configuration of the passenger keypad 32 and the screen configuration of the passenger display 33 can be varied depending on user interface for the passenger information display unit 30 in the control program of the controller 10.

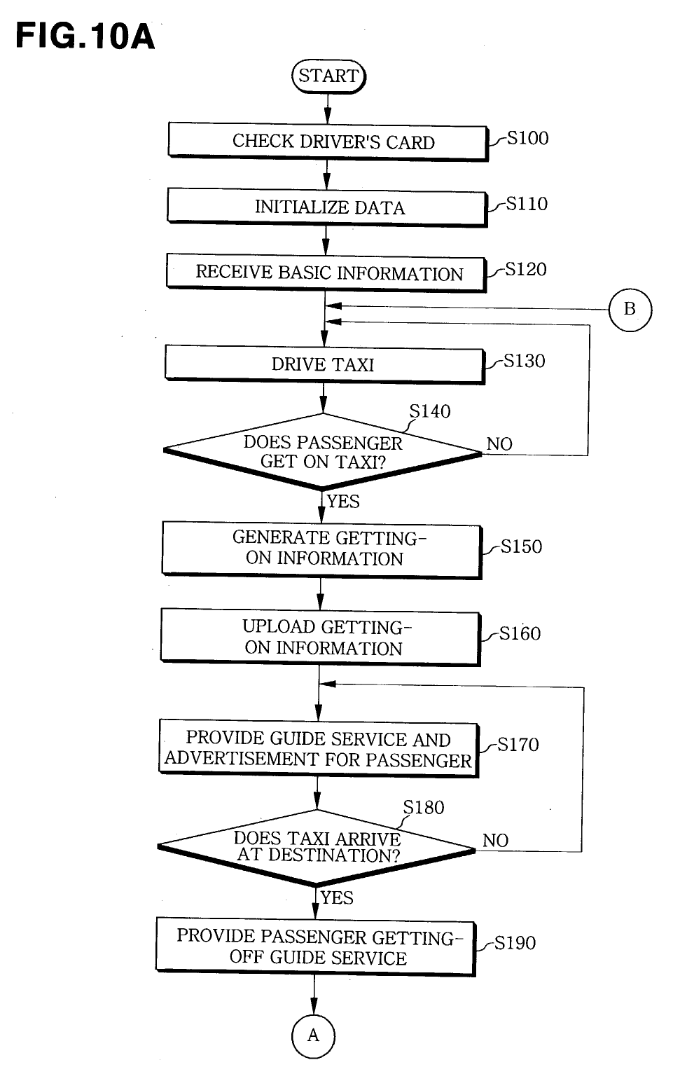

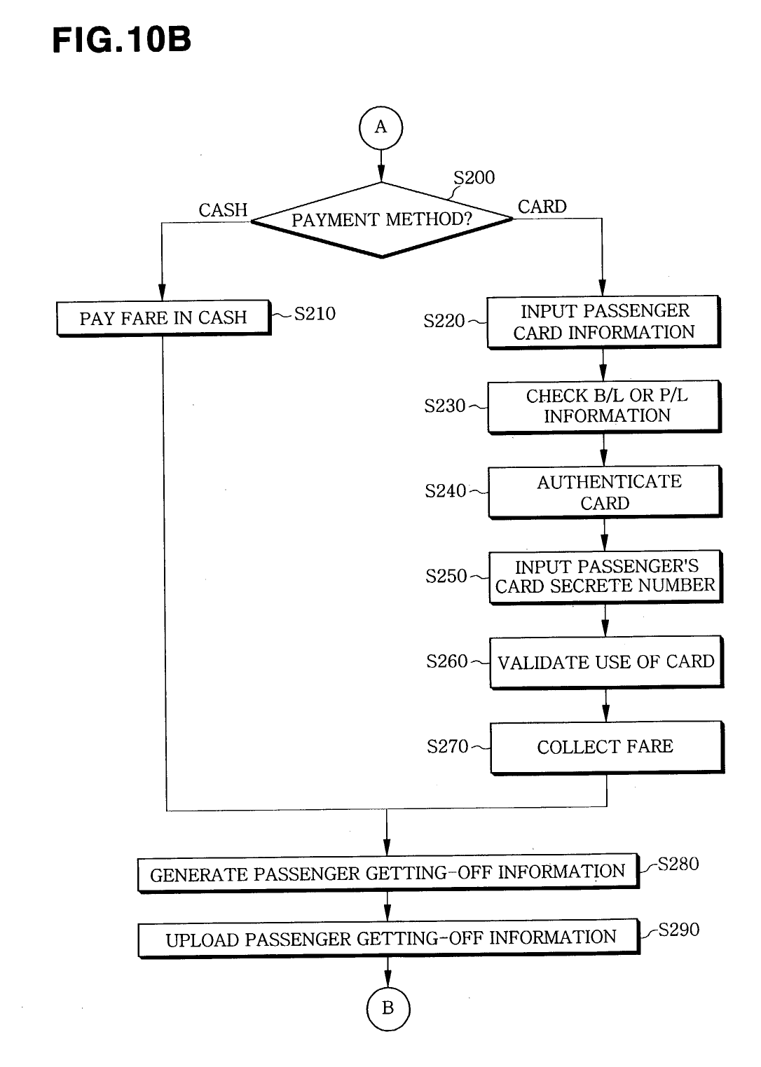

Procedures of collecting a taxi fare and providing additional services to a driver and a passenger using the taxi fare collection terminal 7 according to the present invention will be described in detail with reference to FIGS. 10A and 10B.

A driver enters the taxi 1, turns on the power of the taxi fare collection terminal 7, and brings the driver's RF card 40 to approach the antenna 21_2 of the driver operation panel 20. Then, the RF card reader 21_2 of the driver operation panel 20 reads card security information and driver information from a card signal received through the antenna 21_2. The SAM 21_3 checks the validity and security of the driver's RF card 40 based on the card security information. The RF card reader 21_1 transmits the valid driver information to the MPU 11 of the controller 10. The MPU 11 executes the control program stored in the ROM 12_1. While the control program is executed, the MPU 11 identifies the driver based on the driver information received from the driver operation panel 20, generates information such as a driver's shift schedule, and stores the information in the flash memory 12_3 as logging information in step S100. The MPU 11 initialize taxi service information of the driver in order to allocate a recording area for new logging information in step S10.

Thereafter, the controller 10 controls the driver display 23 of the driver operation panel 10 to display a basic menu. When the driver selects an item (an additional service request command) for receiving additional service information and B/L or P/L information from the basic menu, the controller 10 requests an additional service from the service providing server 3, receives the additional service information and B/L or P/L information from the service providing server 3, and stores them in the flash memory 12_3 in step S120.

While the driver runs the taxi 1 in step S130, when a passenger gets on the taxi 1 in step S140, the driver operates the driver keypad 22 of the driver operation panel 20 to generate a passenger getting-on information upload command in step S150. Then, the controller 10 generates passenger getting-on information and uploads it to the service providing server 3 in response to the passenger getting-on information upload command in step S160.

While running the taxi 1 to the passenger's destination, when the driver selects an item “provide additional service” from the basic menu on the driver display 23 of the driver operation panel 20, the controller 10 controls the passenger information display unit 30 to display the selected additional service on the passenger display 33 according to a predetermined schedule in step S170. When the driver selects an item “passenger guide service” from the basic menu, the controller 10 controls the passenger information display unit 30 to superimpose a selected guide message (for example, “Fasten your seat belt, please”) on the additional service displayed on a screen of the passenger display 33 in step S170.

When the taxi 1 arrives at the destination in step S180, the driver operates the driver keypad 22 of the driver operation panel 20 to generate a fare calculation command. Then, the controller 10 receives fare information from a taxi meter and controls the passenger information display unit 30 to display a message (for example, “The fare is 2.50 dollars. Cash or card?”) asking a settlement method on the passenger display 33 in step S190.

When the passenger selects cash payment in step S200, the driver receives the fare in cash and gives the passenger the change in step S210. When the passenger selects card payment, the driver selects a “card payment” from the menu. Then, the controller 10 controls the passenger information display unit 30 to display a message (for example, “Bring your card near the right side of the keypad”) for guiding the card payment on the passenger display 33. If the passenger brings his/her RF card 50 near to the antenna 31_2 of the passenger information display unit 30, the RF card reader 31_1 of the passenger information display unit 30 reads card security information and passenger card information from a card signal received through the antenna 312, then the SAM 31_3 checks the validity and security of the passenger's RF card 50 based on the card security information, and then the RF card reader 31_1 transmits the valid passenger card information to the controller 10, in step S220. The controller 10 compares the passenger card information received from the passenger information display unit 30 with the B/L or P/L information stored in the flash memory 12_3 in step S230 to authenticate the card in step S240.

Thereafter, if the card is authenticated, the controller 10 controls the passenger information display unit 30 to display a message (for example, “Please, input your card secrete number”) for guiding to input a card secrete number on the passenger display 33. In steps S260 through S270, when the secrete number input by the passenger through the passenger keypad 32 is the same as that contained in the passenger card information, the controller 10 confirms that the passenger is a valid owner of the card and settles the payment of the fare. Here, payment information is stored in the flash memory 12_3 as logging information.

After the cash or card payment is completed, the driver operates the driver keypad 22 of the driver operation panel 20 to generate a passenger getting-off information upload command. Then, the controller 10 generates passenger getting-off information in step S280 and uploads it to the service providing server 3 in step S290.

In the meantime, after step S130, the controller 10 receives vehicle position information from the GPS receiver 15 with a predetermined period (for example, of one minute) and uploads it to the service providing server 3. In addition, in step S130, the controller 10 receives a call message from the service providing server 3 and display it on the driver display 23 of the driver operation panel 20 so that the driver can check the call message.

In the above-described taxi fare collection terminal 7, a passenger's RF card is authenticated using B/L or P/L information, which was previously downloaded in an off-line state in which the taxi fare collection terminal 7 is not connected to the financial company server 4 or the service providing server 3. However, in another embodiment of the present invention, in order to authenticate a passenger's card, the taxi fare collection terminal 7 can access the financial company server 4 or the service providing server 3 given an authority, provide passenger card information, and receive an authentication number from the financial company server 4 or the service providing server 3. Modifications of the above-described embodiment of the present invention made for such on-line settlement can be easily understood by one of ordinary skill in the art of the present invention, and thus a detailed description there of will be omitted.

According to the present invention, a taxi fare can be safely and conveniently paid using a passenger's RF card in taxi in which a safety shield is installed between driver's seat and passenger's seat. In addition, call information can be provided to a taxi driver, and various additional services can be provided to a passenger, so the present invention establishes the base of a new type of business.

While this invention has been particularly shown and described with reference to preferred embodiments thereof, it will be understood by those skilled in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A taxi fare collection terminal connected to a service providing server through a wireless network, the taxi fare collection terminal comprising a controller, a driver operation panel, and a passenger information display unit,
the controller including a plurality of input/output ports for connection to a taxi meter, the driver operation panel, and the passenger information display unit and a wireless communication unit communicating with the service providing server through the wireless network, receiving black list (B/L) information or positive list (P/L) information from the service providing server and managing the B/L or P/L information, controlling the passenger information display unit to display fare information received from the taxi meter, comparing passenger card information received from the passenger information display unit with the B/L or P/L information to settle the payment of a taxi fare, and transmitting additional service information received from the service providing server to the driver operation panel and/or the passenger information display unit;
the driver operation panel being installed in front of driver's seat, being connected to an input/output port of the controller, and comprising a driver card reader unit, which wirelessly reads driver card information from a driver's card and transmits the driver card information to the controller, a driver keypad receiving selection commands from the driver, and a driver display outputting information received from the controller; and
the passenger information display unit being installed in front of passenger's seat, being connected to an input/output port of the controller, and comprising a passenger card reader unit, which wirelessly reads passenger card information from a passenger's card and transmits the passenger card information to the controller, a passenger keypad receiving card secrete number from the passenger, and a passenger display outputting information received from the controller.

2. The taxi fare collection terminal of claim 1, wherein the controller comprises:
a microprocessor;
a memory unit comprising a read-only memory (ROM) for storing a control program executed in the microprocessor, a random access memory (RAM) for storing data processed during the execution of the control program, and a flash memory fro storing additional service information, logging information, and B/L or P/L information;
a wireless communication unit communicating with the service providing server through the wireless network; and
an input/output port unit composed of the plurality of input/output ports for connection to the taxi meter, the driver operation panel, and the passenger information display unit.

3. The taxi fare collection terminal of claim 2, wherein the controller generates additional service request information in response to a selection command received from the driver operation panel, uploads the additional service request information to the service providing server, receives the additional service information and the B/L or P/L information from the service providing server, and stores the additional service information and the B/L or P/L information in the flash memory.

4. The taxi fare collection terminal of claim 1, wherein the controller comprises a global positioning system (GPS) receiver, which receives vehicle-position information from a satellite, uploads the vehicle position information received through the GPS receiver to the service providing server with a predetermined period, generates passenger getting-off or on information in response to a selection command received from the driver operation panel, uploads the passenger getting-off or on information to the service providing server, receives a call message from the service providing server, and transmits the call message to the driver operation panel.

5. A taxi fare collection terminal connected to a service providing server through a wireless network, the taxi fare collection terminal comprising a controller, a driver operation panel, and a passenger information display unit, the controller including a plurality of input/output ports for connection to a taxi meter, the driver operation panel, and the passenger information display unit and a wireless communication unit communicating with the service providing server through the wireless network, controlling the passenger information display unit to display fare information received from the taxi meter, making an on-line connection to the service providing server to transmit passenger card information received from the passenger information display unit to the service providing server in order to settle the payment of a taxi fare, and transmitting additional service information received from the service providing server to the driver operation panel and/or the passenger information display unit;
the driver operation panel being installed in front of driver's seat, being connected to an input/output port of the controller, and comprising a driver card reader unit, which wirelessly reads driver card information from a driver's card and transmits the driver card information to the controller, a driver keypad receiving selection commands from the driver, and a driver display outputting information received from the controller; and
the passenger information display unit being installed in front of passenger's seat, being connected to an input/output port of the controller, and comprising a passenger card reader unit, which wirelessly reads passenger card information from a passenger's card and transmits the passenger card information to the controller, a passenger keypad receiving card secrete number from the passenger, and a passenger display outputting information received from the controller.

6. The taxi fare collection terminal of claim 5, wherein the controller comprises:
a microprocessor;
a memory unit comprising a read-only memory (ROM) for storing a control program executed in the microprocessor, a random access memory (RAM) for storing data processed during the execution of the control program, and a flash memory fro storing additional service information and logging information;
a wireless communication unit communicating with the service providing server through the wireless network; and
an input/output port unit composed of the plurality of input/output ports for connection to the taxi meter, the driver operation panel, and the passenger information display unit.

7. The taxi fare collection terminal of claim 6, wherein the controller generates additional service request information in response to a selection command received from the driver operation panel, uploads the additional service request information to the service providing server, receives the additional service information from the service providing server, and stores the additional service information in the flash memory.

8. The taxi fare collection terminal of claim 5, wherein the controller comprises a global positioning system (GPS) receiver, which receives vehicle position information from a satellite, uploads the vehicle position information received through the GPS receiver to the service providing server with a predetermined period, generates passenger getting-off or on information in response to a selection command received from the driver operation panel, uploads the passenger getting-off or on information to the service providing server, receives a call message from the service providing server, and transmits the call message to the driver operation panel.
